(19) United States
(12) Patent Application Publication
(10) Pub. No.: US 2006/0152532 A1
(43) Pub. Date: Jul. 13, 2006

(54) The largest toy gallery park with 3D simulation displays for animations and other collectibles juxtaposed with physical-virtual collaborative games and activities in a three-dimension photo-realistic virtual-reality environment

(75) Inventor: Prabir Sen, Glenview, IL (US)

Correspondence Address: PRABIR SETN, 18 WASHINGTON STREET, GLENVIEW, IL, 60025, US

(73) Assignee: Prabir Sen, Glenview, IL (US)

(21) Appl. No.: 10/709,394

(22) Filed: Sep. 9, 2004

Related U.S. Application Data
(60) Provisional application No. 60/481,432, filed on Sep. 29, 2003.

(51) Int. Cl. G09G 5/00

(52) U.S. Cl. 345/629

(57) ABSTRACT

What is the value of physical context for virtual interaction?—Swiss-house: A prototype physical/virtual collaborative environment: Jeffrey Huang and Muriel Waldvogel, Harvard University, Paper submitted for WACE 2002; 2) Method and system of rendering a virtual three-dimensional graphical display (U.S. Pat. 6, 452,593); 3) Method of creating virtual reality (U.S. Pat. 6,084,979).

### BACKGROUND OF INVENTION

Almost all amusement parks have traditional dark and thrill rides including some water rides. These rides are surrounded with carnival type spot entertainment including meeting and playing with popular animated characters. Most of these rides are passive in nature visitors sit in a vehicle or floatation device and experience the thrill or environment of the ride and location of the park.

Most amusement parks have traditional building structures with audio, video and light to create a thematic environment for visitors to experience the location or the ride. Most of them are based on physical movement of the item, vehicle or device. Most of these structures—the building, the interior design, the audio and video, the theme—are relatively less dynamic (not changed too often) in nature.

The present invention is generally relates to a toy gallery and theme park which is a juxtaposition of toys and animation characters with experiential, participatory and interactive games in a digital animation and 3D simulation environment.

The park has nine galleries with both thematically created environment with traditional display materials as well as three-dimensional virtual reality display (one of the methods could be a three-dimensional virtual reality space display processing method, U.S. Pat. 6,437,777) of various toys, animation characters and other collectibles. These three-dimensional rendering virtual-reality displays for interactive, i.e., voice activated chat-enabled devices that communicate with the visitors in terms of providing information through a medium or requesting pre-determined data input and status message indicating a communication state.

In the toy gallery park, each gallery also has five game complexes (much like Cineplex) for interactive, participatory games in a 3D simulation environment, each game complex is catering to each age cohort. Each game-complex has 3D phot0-realistic simulation environment has apparatuses that are synchronized with audio-means, visual means and physical means which allows participants to interact with the apparatus (could be a human shaped mannequin or any other physical or virtual object) for visual and audio outputs in a manner corresponding to participant movements and engagements with the physical apparatus movements and position sensing means and responding to a part of the body of the participant and adapted to provide a control input to the computer based system.

in such artificial and highly dynamic environments all parameter setting are fully controllable. Thus a simulation framework is based on a service-oriented concept is proposed in order to facilitate the integration of physical virtual collaborative environment modules, e.g., particular sensors, environmental artifacts and even additional platform for robots (avatar). This ensures that existing photo-realistic 3D rendering or robotic applications are used various apparatuses in the same way.

### SUMMARY OF INVENTION

In one embodiment, the present invention is the gallery theme park which is a juxtaposition of various toy and animation characters from different toy and animation creators with participatory, experiential and interactive games in digital animation and three-dimensional simulation environment. The park has nine galleries. each gallery has museum, multiple game complexes and retail store. The museum provides a mechanism to display various toys, action figures and other collectible items that are applicable to a gallery in an amusement park providing an unique experience and attention-based interaction in a virtual-reality environment . In carrying out such invention we have provided three-dimension photo-realistic display environment in claim 1 which will provide information about the physical display items or collectibles and interact with the participant for questions and answers. This will also allow participant to interact with a subject (called “Kalpona”—a Indian Hindu mythological rendition of imagination) based on his or her movements.

Another embodiment of the internal representation is based on the concept of providing a new combination of features offering a substantial advance in the potential to heighten human senses in three-dimension photo-realistic virtual environment of an amusement park to achieve interactive, participatory experiential games and activities. In one aspect the present invention consists in an apparatus for providing a virtual reality games and activity experience, the apparatus including audio output, video output and physical sensors. The apparatus further comprising a control system to synchronize audio, visual and physical of the participant to relate to one another. The apparatus further connected to computer based systems to process participant's physical and audio outputs and its interaction with the physical object to provide a three-dimension photo-realistic virtual-realty scenario update which is selected from a database and advances in a manner corresponding to user movements and engagements with the physical movement.

Let me set up a picture. As a participant enters in the gallery a frog (a three-dimension photo-realistic virtual reality image) appears on a display screen comes and says, “Hey, you with the red color shirt, what is your name” and as the participant walks through the gallery, the frog walks with him and starts making conversation. “What is your special interest in animation?” the frog asks to the participant. As the participant answers that the scenarios and surrounding changes. “Cartoons” the participant answers. Based on participants response and movements the three-dimension photo-realistic virtual reality images change. “Here is the paper and pencil, why don't you make a cartoon?” the frog hands down the paper and pencil (the physical object). Based on the participants hand movements, the frog narrates the various styles of animation creation and displays toys or animation figures. All these are sequentially simultaneously for many participants.

The present invention overcomes three primary problems in the prior work. In the present invention three-dimension photo-realistic virtual reality is created from images taken by the cameras because of which the virtual world has the fine detail which is photo-realistic. Second, because the information is stored and processed from both physical and virtual objects—both in audio and video, it enhances the experience of the interaction between physical-virtual collaboration as it generates virtualized images from any angle or viewing position. This also frees the participant to explore from any vantage point and not just prerecorded vantage point. Third, the processing of information and scrolling with the virtual subject (Kalpona) is so fast and personalized that it creates different three-dimension photo-realistic virtual reality images (the fine detail captured by the cameras to be viewed in a way that CAD modeled environments are viewed) and thereby experience to different participants at the same time.

### BRIEF DESCRIPTION OF DRAWINGS

For the present invention to be clearly understood and readily practiced, the present invention will be described in conjunction with the following figures wherein:

FIG. 1: The physical look of the park with the physical structure and the way it is constructed as half-underground with the “cooling leaves” on top of it

FIG. 2: The gallery design and framework

FIG. 3: The watchdog game framework

FIG. 4: The reflective car racing track

FIG. 5: The Animation Story-land

FIG. 6: Emonic Games design

FIG. 7: Space Invader design

FIG. 8: is a block diagram how the physical structure and how images are recorded by a plurality of cameras

FIG. 9: is the data flow diagram illustrating signal processing

FIG. 10: is the physical object embodiment

FIG. 11: is the pictorial illustration of a user environment reflected in a graphical environment according to the method and system of the present invention

FIG. 12: is the pictorial illustration of a user environment from a perspective of ‘kalpona’ according to the method and system of the present invention

### DETAILED DESCRIPTION

The present invention is the largest toy gallery theme park which is ajuxtaposition of various toys, animations, action figures and other collectible characters from different toy and animation creating companies with participatory, experiential interactive games.

The gallery park has nine galleries, each gallery has museum, five game complexes and retail store. Each of the five game complexes, catering to different age cohort, has different themes. The game complex will use the museum “theme” and toys to create an environment for the participatory game. For example: G.l. Joe characters in the museum and the same characters with all the G.l. Joe accessories creating an environment for a game—say laser tag. These environments will created in 3D simulation, as rendition of physical-virtual interactivity

The present invention is also directed to a new visual rendition of the museum items which we referred to as three-dimension photo-realistic simulation. The physical objects (toys, action figures and other collectibles) that are displayed in the gallery are: toys, action figures, dolls, miniature automobiles, miniature trains, coins, photographs, paintings, moving pictures, moving toys, and other collectibles (hereinafter known as “physical displays”). To be more specific, for example, miniature cars are displayed in on a ‘black’ platform (hereinafter considered as “physical object”) which gives a look of a ‘highway.’

The host A stores three-dimensional image data for providing three-dimension photo-realistic virtual reality displays (hereinafter referred as PRVR displays) such as streets of New York, London or other locations. These PRVR data has been collected for numerous situations—such as London road during winter, traffic jam, accident, earthquake, etc. and, therefore, do not change. When the basic data are not subject to update. This system provides the PRVR images of buildings, roads and other items to create an environment. The host A also stores data related to physical displays to trigger as audio input.

The host B controls update objects that constitute both audio output and a PRVR space. The update objects are avatars for example representing the visitors' response.

Thus, the host B allows a plurality of visitors (or users) to share the same virtual space. It should be noted that the host B controls only the update objects located in the display area (for example the virtual-reality display of New York) controlled by host A.

The virtual-service provider (hereinafter called “Kalpona”) is like a client terminal which receive voice-activated data (from the visitors) and the sensor data (the physical movement based on camera movement of the visitor) and synchronize them to provide the input to the host B.

What follows, a procedure of communication between the visitor (or user)and ‘Kalpona’ are recorded and updated in the host B which triggers host A to display and/or generate audio output based on the information request from host B. A predetermined display attribute can be attached to overlay message. if the attached display attribute is for specifying scrolling or moving (synchronized with visitor movement) the overlay message is displayed in a scrolled manner (giving an impression of movement). If the display attribute is for specifying reverse display, flashing, coloring, or display sizing, the overlay message is displayed as specified.

In addition to the above mentioned messages, there are such messages as a title and words of music to be played in a virtual reality space.

To generate data for the three-dimension photo-realistic virtual reality medium, images are recorded using cameras positioned to cover the events from all sides. As used herein, images could be discreet objects, environments, objects interacting with an environment. Each camera produces a series of images with each image being comprised of a plurality of pixels. The depth information is further manipulated to produce object-centered descriptions of everything within an image. We develop the stand-alone system to synchronously record frames from multiple cameras. The output of each camera is time stamped with a common Vertical Interval Time Code (VITC). The time code allow us to correlate the frames across cameras which is crucial when transcribing movements and triggering effect through host A.

Another embodiment may be implemented with the apparatus including a mannequin, or doll or a part thereof fitted with appropriate sensors which is connected to the control system to advance the audio and visual outputs corresponding to user movement or manipulation of the mannequin or doll. So, now imaging a little girl (user) dancing with ‘Barbie’ doll.

In a preferred embodiment control of the system is through the data glove or equivalent device. This is used by user physical movements to e.g., select from menus in the computer system.

All major motions must be monitored and processed by the PC in real-time. One known motion tracking system is called Motion Star wireless from Ascension Technologies.

It is a wireless solution that can read up to 20 sensors in real-time. This kind of tracking is known as 6DOF (Six Degrees of Freedom) tracker. This allows the major movements of the human to be monitored by the system and the information to be processed and applied to the users “kalpona.”

The mannequin or doll is intended to be life-size form and have legs, arms, head and body. Outer structure would be of a flexible plastic material and closely mimic the touch of a human body. The mannequin or doll will be responsible for providing any information (i.e., where it has been touched or what has been spoken to). This information is transmitted to PC via an interface card and the software.

As the interaction with the mannequin or doll changes, the information recorded in PC triggers host A to change the environment or updates with new three-dimension photo-realistic virtual reality environment.

Yet another solution is to allow users or visitors to walk on a “walking belt” and the sensors are attached to the persons legs and feet can be monitored for walking or running movement and thus can be moved accordingly within the virtual environment.

1. A theme park with a juxtaposition of existing toy and animation characters from multiple toy and animation creating companies with interactive, participatory, experiential games for children and families
providing toy and animation characters in the museum for display and the same characters creating a thematic environment in the game complexes (for example: G.I. Joe characters in the museum and the same characters with all G.I. Joe accessories creating an environment for a game—say laser tag) for children to play with their favorite toy and animation characters
providing unique games and activities in the game complexes which are never played before (these will be patented separately)

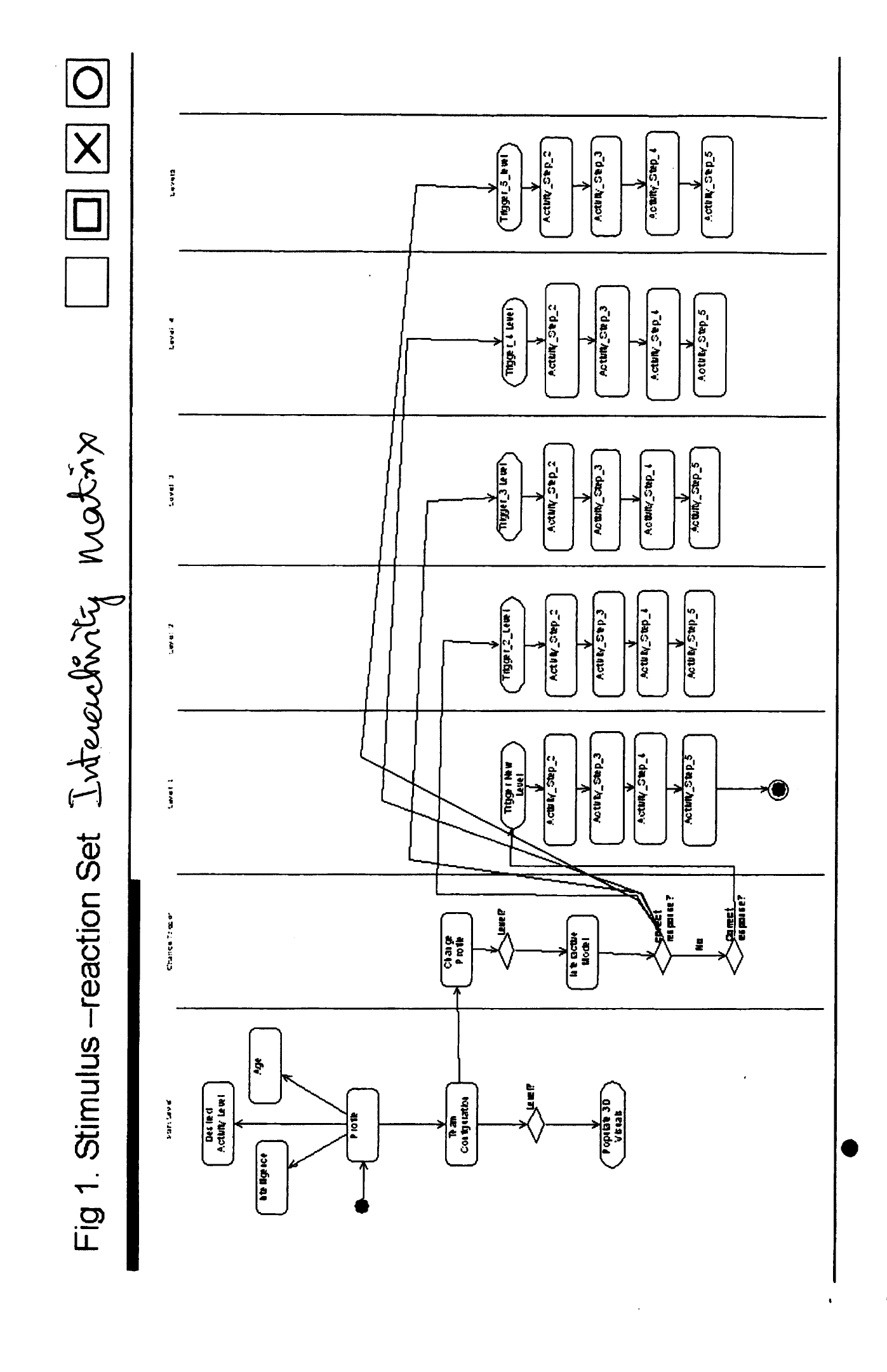

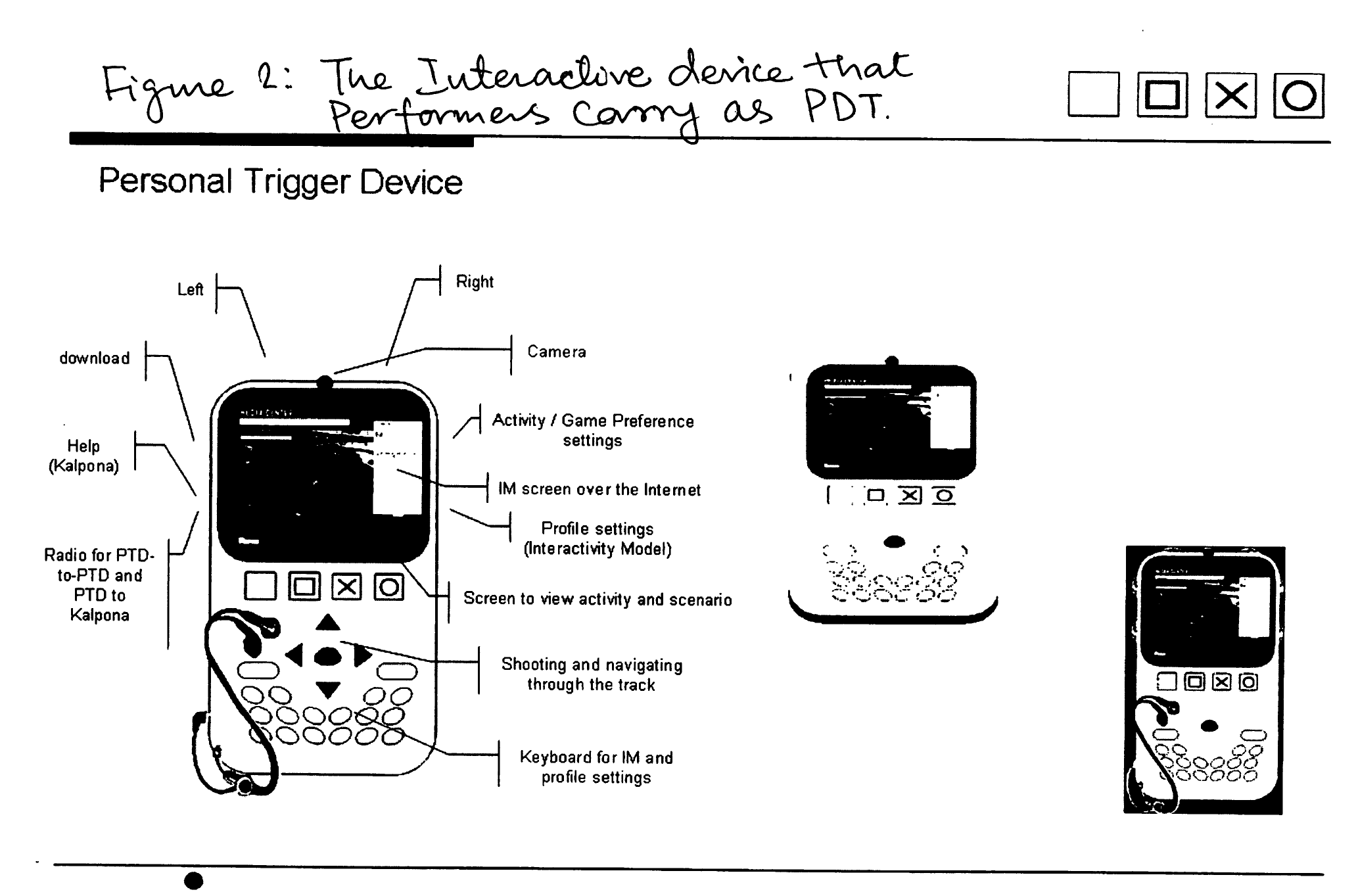

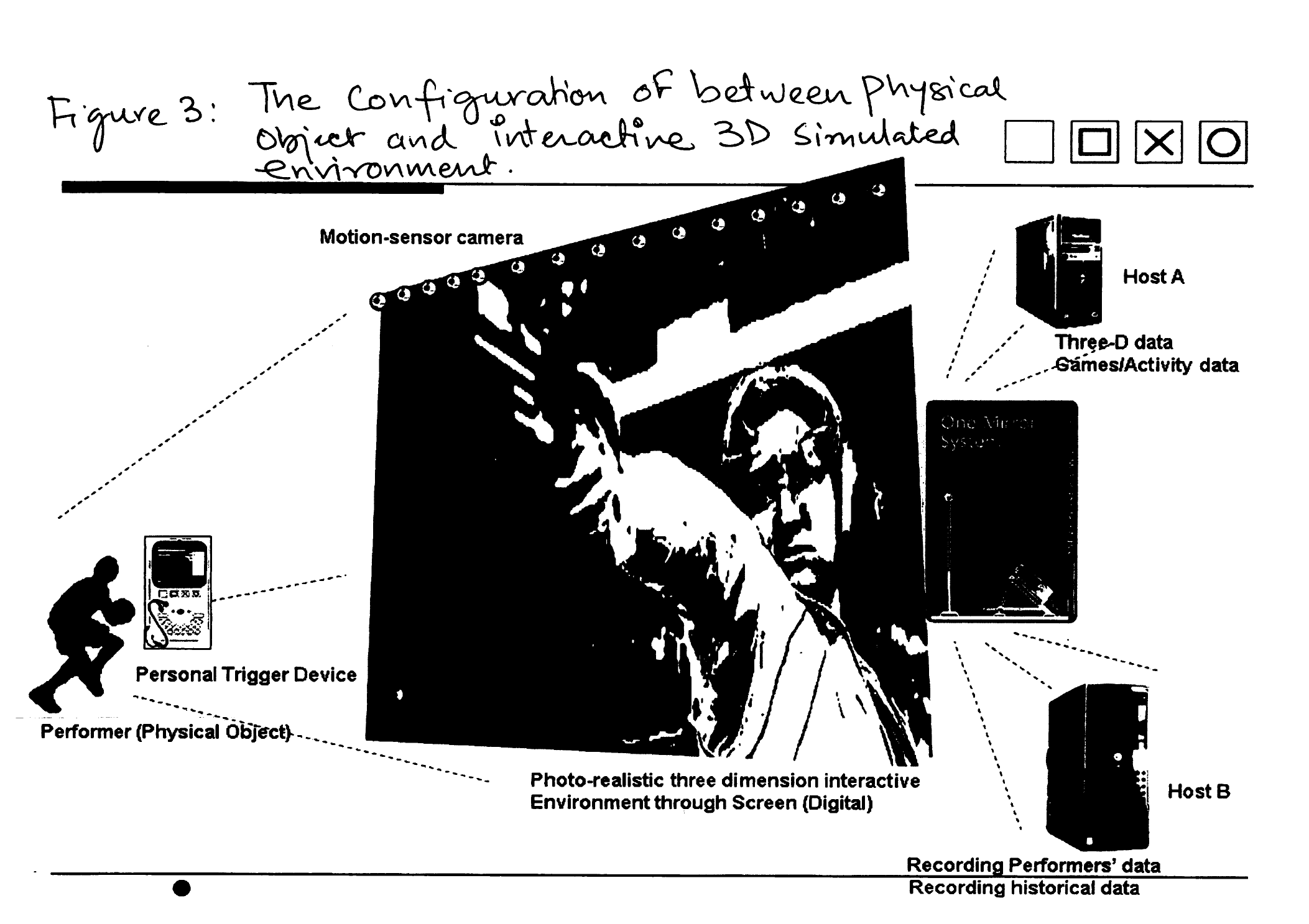

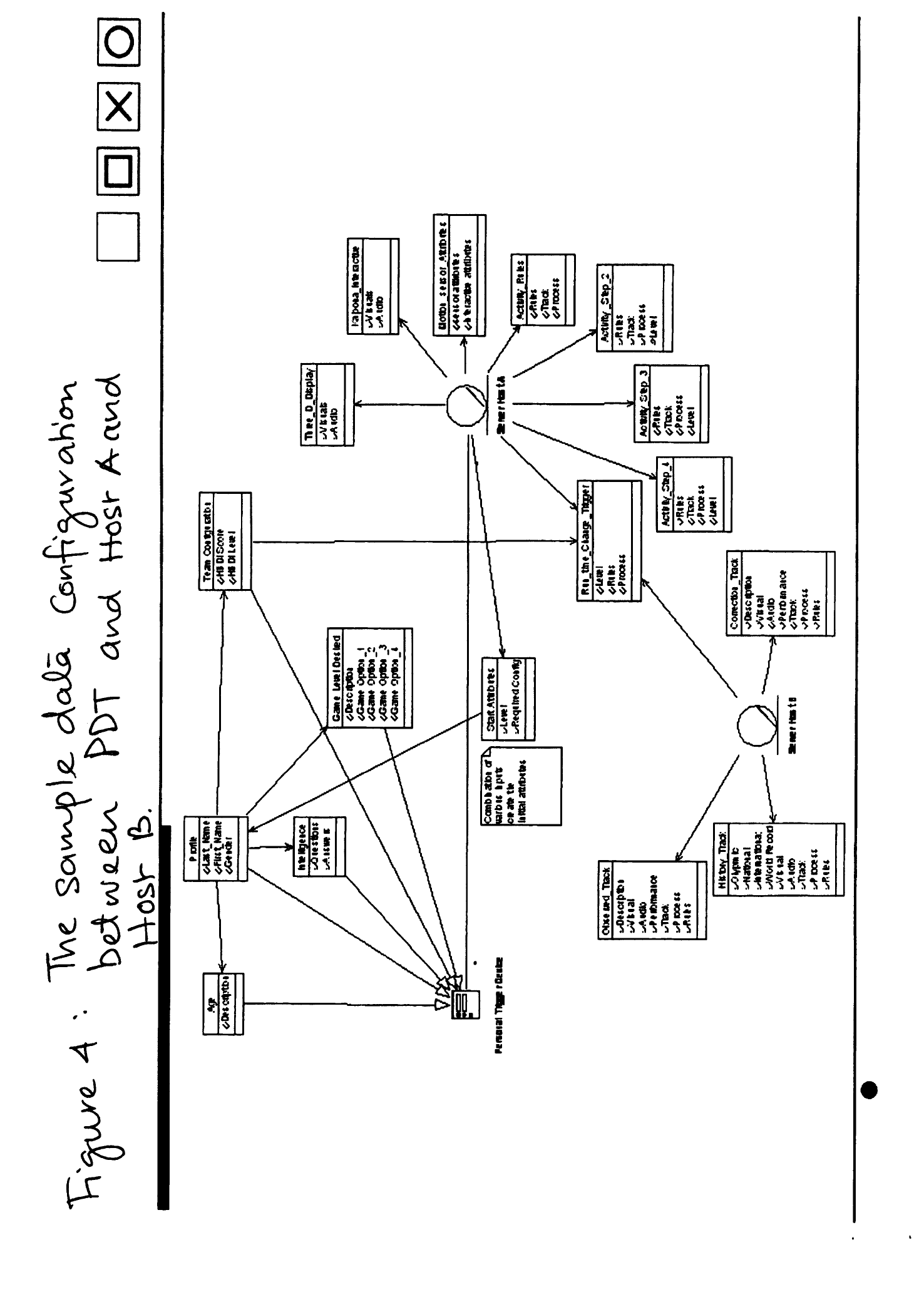

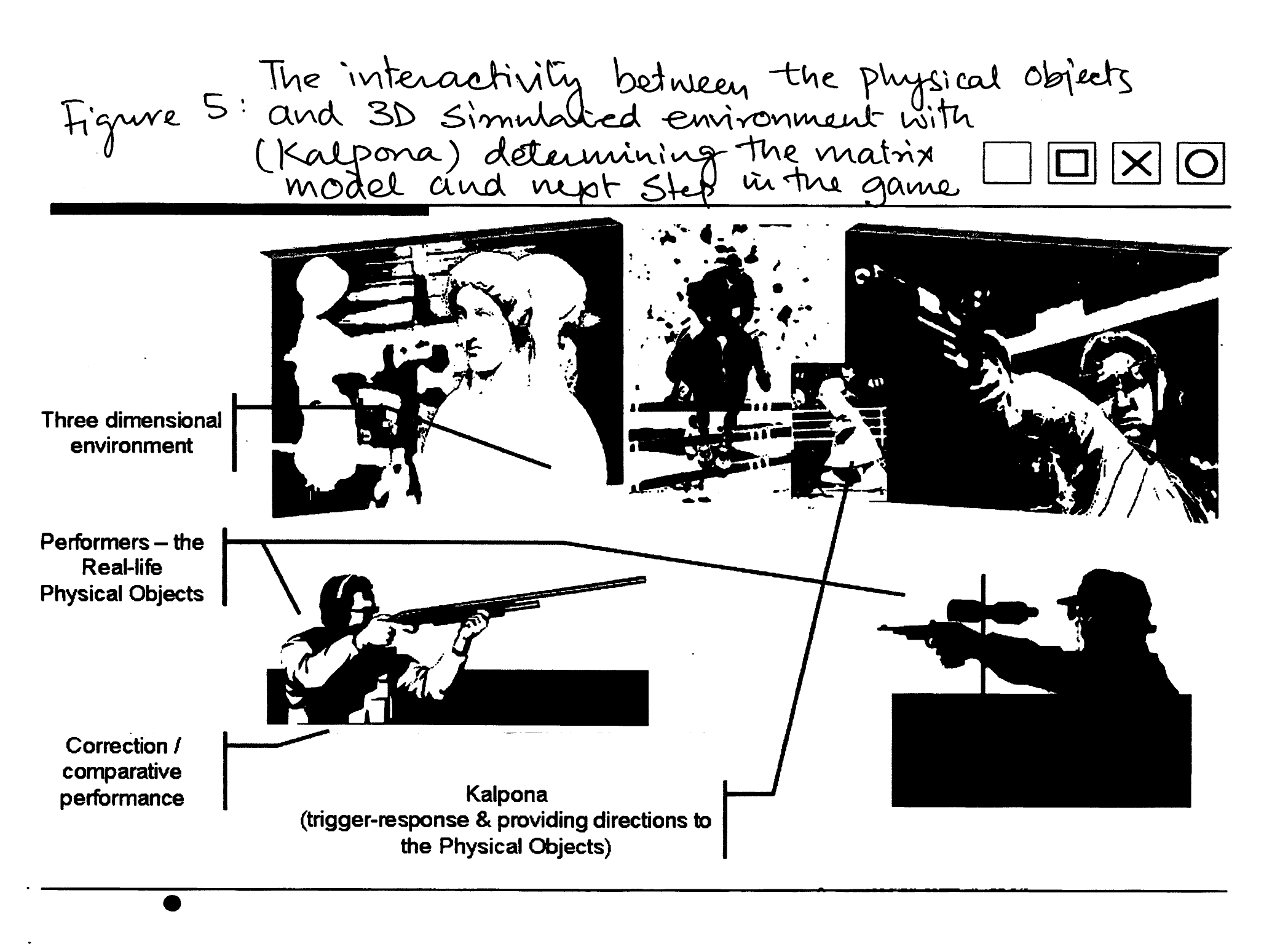

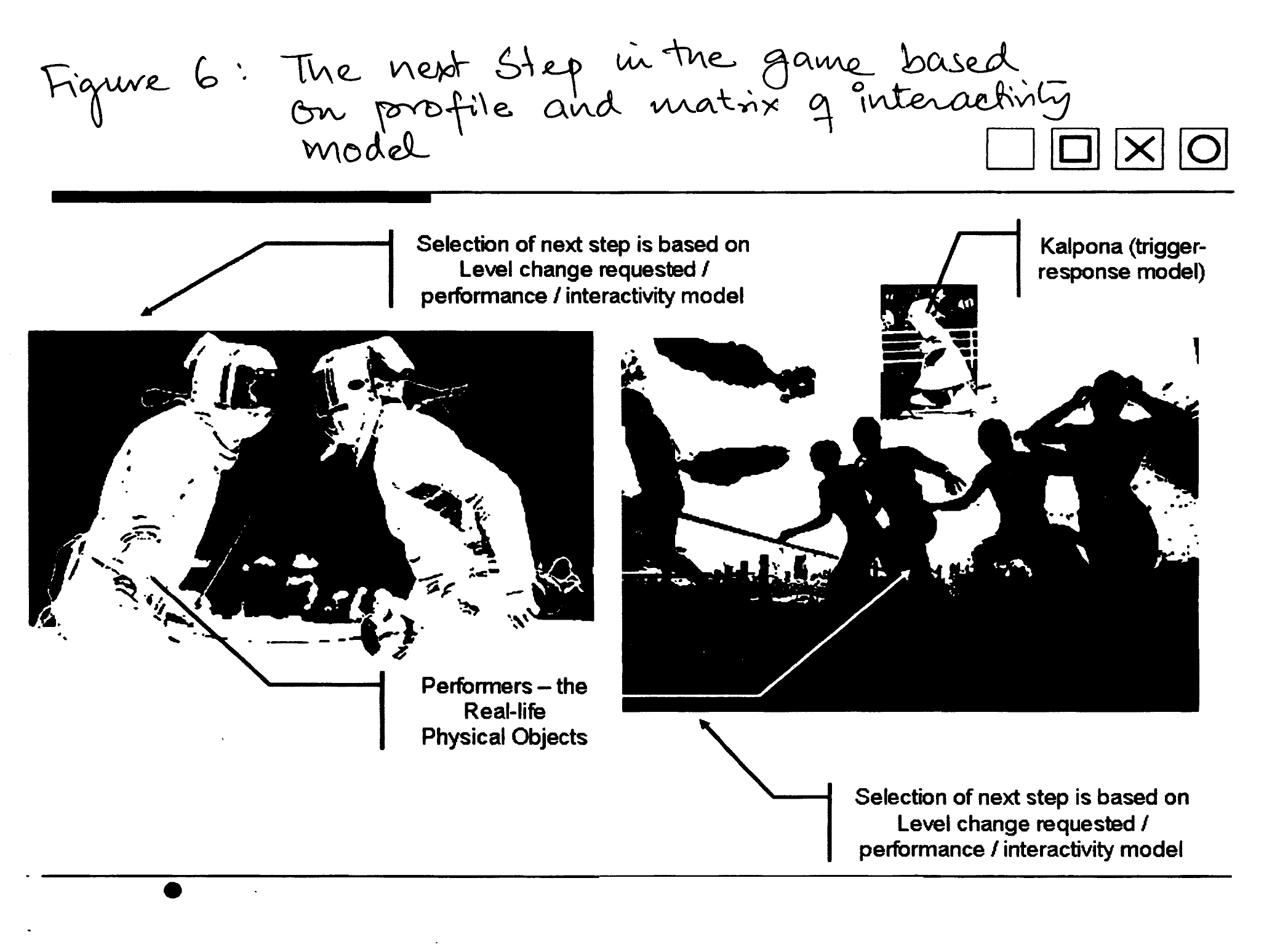

2. A theme park with the design of the shade of multiple “cooling leaves” where each cooling leave has solar panel to generate solar energy (see FIG. 1)
design of nine galleries which are constructed as “half underground” by shifting the land and creating dunes
design of the “cooling leaves”—the look and feel—for the theme park to create shade
providing ‘mist’ in the surrounding the green area for cool and air-conditioning effect

3. (canceled)

4. (canceled)

5. A three-dimension photo-realistic virtual reality display (to display toys and animation characters or other collectibles) in a physical world that display three-dimensional photo-realistic virtual reality images on a display device comprising:
providing interactive digital video information related to physical items that are displayed in the gallery to a three-dimensional virtual reality display screen according to the theme selected for the display
super-imposed interactive digital audio information related to physical items that are relayed into a pre-set area within said three-dimensional virtual reality in a synchronized overlay manner according to the theme selected and displayed

6. A set of media or apparatuses that capture response—both movement and audio—from the participant and recorded in a computer-based device on a display device of claim 5 for processing and triggering three-dimension photo-realistic virtual reality images.

7. The apparatus of claim 6 further comprising rendering both video and audio outputs for information update about three dimensional photo-realistic virtual reality display images
wherein said apparatus acquire information corresponding to a connection state of information means

8. The set of media or apparatuses of claim 6 further comprising information gathered from the participant—physical movement, eye movement and audio—to trigger the apparatus of claim 4 to initiate or an update

9. The apparatus of claim 6 and claim 7 where three-dimensional graphic data is described in VRML (virtual reality modeling language) and photo-realistic image rendering applications

10. The apparatus of claim 8 wherein said information superimposed displays images in a pre-set area of said three-dimensional photo-realistic virtual reality images on a physical display and display screen in a pre-determined scrolled manner thus creating interactive experience

11. (canceled)

12. (canceled)

13. (canceled)

14. A user interactive apparatus for providing a virtual-reality sporting or inter-activity experience on a three-dimension photo realistic virtual-rality display device as claimed above in claim 5, the apparatus comprising:
audio reproduction means having an audio output
visual reproduction means having three-dimensional photo-realistic virtual-reality visual output
the physical object (mannequin or other physical objects) which is superimposed with three-dimensional photo-realistic virtual-reality images to create an environment
a control system synchronizing and interrelating the audio, video and physical movements relative to one another
the control system including a data base and computer based system for providing a scenario output for the audio output and the three-dimensional photo-realistic visual output
the physical object (mannequin or other physical object) further having control signal generators that are responsive to the movement (sensor) and the position(sensor) and that provide signal outputs that are received by the control system and that are responsive to, representative of, and synchronized with the body movement of the participant when the participant is so associated with the physical activity
the control system further including software that is responsive to database and to the received signal outputs, and that regulates the scenario content so that the audio output and the visual output are synchronized and correspond to the movement of the participant

15. The apparatus of claim 14 wherein the database includes more than one scenario output type and wherein one scenario output type is selectable by the administrator

16. The apparatus of claim 14 which is linked to more than one user in both sequential and simultaneous manner.
